(19) United States
(12) Patent Application Publication
(10) Pub. No.: US 2016/0117232 A1
(43) Pub. Date: Apr. 28, 2016

(54) STORAGE DEVICE

(71) Applicant: KABUSHIKI KAISHA TOSHIBA, Minato-ku (JP)

(72) Inventor: Shinobu SHIMPUKU, Tokyo (JP)

(73) Assignee: KABUSHIKI KAISHA TOSHIBA, Minato-ku (JP)

(21) Appl. No.: 14/988,934

(22) Filed: Jan. 6, 2016

Related U.S. Application Data
(63) Continuation of application No. 13/677,551, filed on Nov. 15, 2012.
(60) Provisional application No. 61/695,591, filed on Aug. 31, 2012.

(51) Int. Cl. G06F 11/20; G06F 3/06; G06F 1/26

(52) U.S. Cl. CPC G06F 11/2094; G06F 1/266; G06F 3/0619; G06F 3/065; G06F 3/0683; G06F 2201/805

(57) ABSTRACT

A storage device of an embodiment includes a voltage measurement unit that measures a voltage of power supplied from a host, a volatile memory, a non-volatile memory including a saving area and a normal area, a data compression and decompression unit, and a controller. The controller includes a power-supply voltage determining unit which compares the voltage measured by the voltage measurement unit to a predetermined threshold value, a data saving unit which writes compression user data obtained by compressing user data by the data compression and decompression unit in the saving area when the voltage is less than the predetermined threshold value and the user data is included in the volatile memory, and a data rewriting unit which writes the compression user data that is decompressed in the normal area when the compression user data is included in the saving area at the time of supplying the power.

### CROSS-REFERENCE TO RELATED APPLICATIONS

This application is based upon and claims the benefit of priority from Provisional Patent Application No. 61/695591, filed on Aug. 31, 2012; the entire contents of which are incorporated herein by reference.

### FIELD

Embodiments of the present invention relate to a storage device.

### BACKGROUND

Generally, when a battery of a host device such as a PC starts to cause a voltage drop, an operating system (OS) performs a shutdown operation to retain user data on a volatile storage device. However, when insufficient time exists until the host device is actually shut down, user data and the like to be retained may be lost without being appropriately retained.

### BRIEF DESCRIPTION OF THE DRAWINGS

FIG. 1 is a diagram illustrating a configuration of a storage device according to a first embodiment together with a host.

FIG. 2 is a flowchart illustrating an operation of the storage device until power is abnormally cut off in the first embodiment.

FIG. 3 is a flowchart illustrating an operation of the storage device at the time of a power resupply after power is abnormally cut off in the first embodiment.

FIG. 4 is a diagram illustrating a format when user data is written in a saving area in the first embodiment.

FIG. 5 is a diagram illustrating a configuration of a storage device according to a second embodiment together with a host.

FIG. 6 is a flowchart illustrating an operation of the storage device until power is abnormally cut off in the second embodiment.

FIG. 7 is a flowchart illustrating an operation of the storage device at the time of a power resupply after power is abnormally cut off in the second embodiment.

FIG. 8 is a diagram illustrating another configuration of the storage device according to the second embodiment together with a host.

FIG. 9 is a diagram illustrating a configuration of a storage device according to a third embodiment together with a host.

FIG. 10 is a diagram illustrating another configuration of the storage device according to the third embodiment together with a host.

FIG. 11 is a diagram illustrating still another configuration of the storage device according to the third embodiment together with a host.

### DETAILED DESCRIPTION

According to an embodiment of the invention, a storage device includes a voltage measurement unit that measures a voltage of power supplied from a host, a volatile memory, a non-volatile memory including a saving area and a normal area, a data compression and decompression unit, and a controller. The controller includes a power-supply voltage determining unit which compares the voltage measured by the voltage measurement unit to a predetermined threshold value, a data saving unit which writes compression user data obtained by compressing user data by the data compression and decompression unit in the saving area when the voltage is less than the threshold value and the user data is included in the volatile memory, and a data rewriting unit which writes the compression user data decompressed by the data compression and decompression unit in the normal area when the compression user data is included in the saving area at the time of supplying the power.

A storage device according to embodiments will be described in detail with reference to accompanying drawings. It should be noted that the invention is not limited to the embodiments.

### First Embodiment

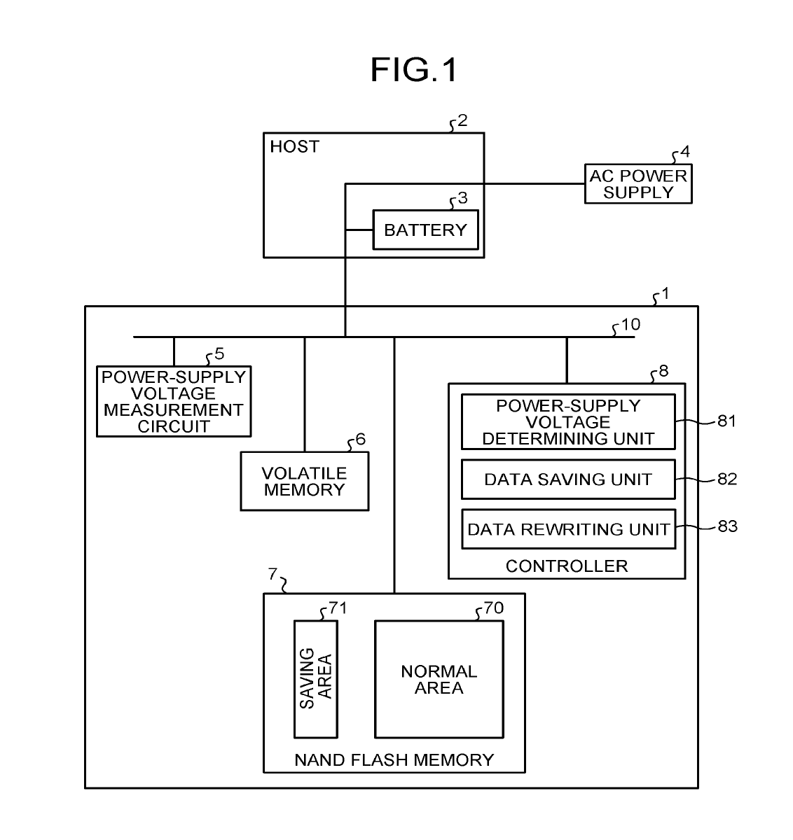

FIG. 1 is a diagram illustrating a configuration of a storage device 1 according to this embodiment together with a host 2. For example, the storage device 1 is a solid state drive (SSD). For example, the host 2 is a personal computer (PC) and the like. A battery 3 included in the inside of the host 2 or an AC power supply 4 in the outside thereof is used as a power supply of the host 2. The storage device 1 includes a power-supply voltage measurement circuit 5 that measures a power-supply voltage supplied from the host 2, a volatile memory 6 that functions as a buffer or a cache, a NAND flash memory 7 which is a non-volatile memory, and a controller 8. The power-supply voltage measurement circuit 5, the volatile memory 6, the NAND flash memory 7, and the controller 8 are connected to the host 2 via a common bus 10. The NAND flash memory 7 includes a normal area 70 that normally retains user data, and a saving area 71 that temporarily saves user data on the volatile memory 6 at the time of a power-supply voltage drop as described below. The normal area 70 and the saving area 71 may differentiate and use physically similar storage areas on the NAND flash memory 7 depending on usage. The volatile memory 6 may be an SRAM and the like of an ASIC that functions as the controller 8.

A firmware (FW) that implements a function of the storage device 1 according to this embodiment is stored in the NAND flash memory 7. However, at the time of startup, the FW is loaded on the volatile memory 6 or an SRAM in the controller 8, and is implemented by the controller 8. Thus, as a functional module that implements the functions, the controller 8 includes a power-supply voltage determining unit 81, a data saving unit 82, and a data rewriting unit 83.

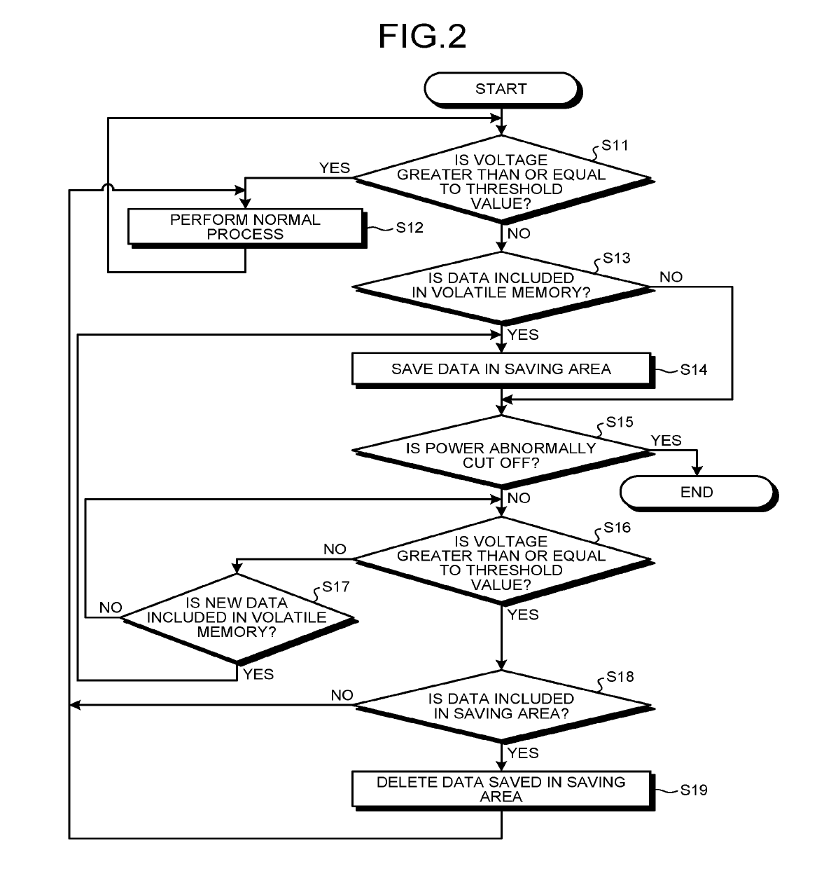

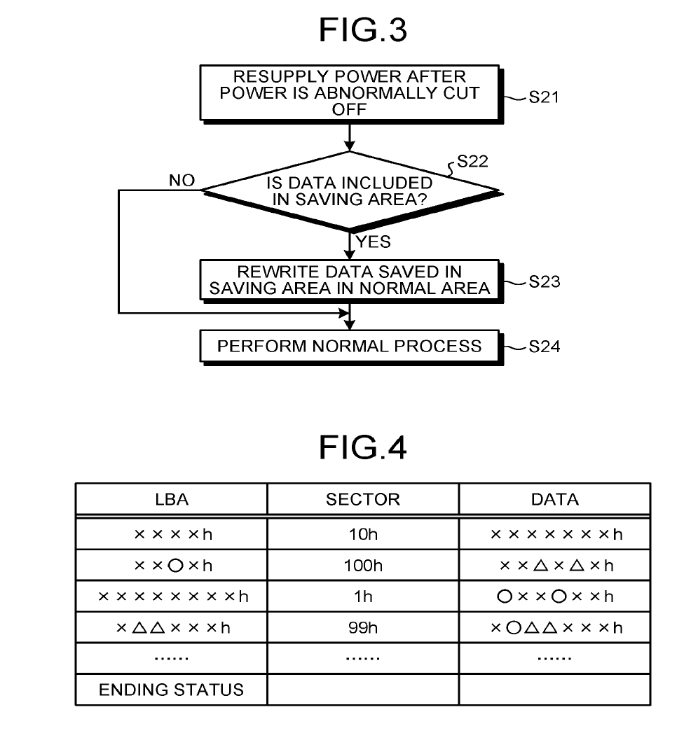

Hereinafter, an operation of the storage device 1 of this embodiment will be described using flowcharts of FIGS. 2 and 3.

FIG. 2 is a flowchart illustrating an operation of the storage device 1 until power is abnormally cut off in this embodiment. First, in step S11 of FIG. 2, the power-supply voltage determining unit 81 determines whether a power-supply voltage, supplied from the host 2, which is measured by the power-supply voltage measurement circuit 5 is greater than or equal to a predetermined threshold value or not.

When the power-supply voltage supplied from the host 2 is greater than or equal to the threshold value (Yes in step S11), the operation proceeds to a normal process (step S12). In the normal process, user data on the volatile memory 6 is written in the normal area 70 of the NAND flash memory 7 at a predetermined timing. After step S12, the operation returns to step S11.

When the power-supply voltage supplied from the host 2 is less than the threshold value (No in step S11), the data saving unit 82 determines whether user data is included in the volatile memory 6 in step S13. When the user data is not included (No in step S13), the operation proceeds to step S15. When the user data is included in the volatile memory 6 (Yes in step S13), the data saving unit 82 converts the user data to a predetermined format including an LBA and sector information illustrated in FIG. 4, and writes and saves the converted user data in the saving area (step S14). The format is a format that may be rewritten in the normal area 70 at the time of a subsequent power supply. For example, the writing in the saving area 71 is performed in a binary recording (SLC: single-level cell) scheme for promptness. After step S14, the operation proceeds to step S15, and it is determined whether power is not normally, that is, abnormally cut off due to a power-supply voltage drop. When power is abnormally cut off (Yes in step S15), the flowchart of FIG. 2 ends.

When power is abnormally cut off (No in step S15), it is redetermined whether the power-supply voltage supplied from the host 2 is greater than or equal to a predetermined threshold value or not (step S16). When the power-supply voltage is less than the threshold value (No in step S16), the data saving unit 82 determines whether new user data is included in the volatile memory 6 in step S17. When the new user data is not included (No in step S17), the operation returns to step S16. When the new user data is included in the volatile memory 6 (Yes in step S17), the data saving unit 82 converts the new user data to the format illustrated in FIG. 4, and writes and saves the converted new user data in the saving area 71 (step S14). When the power-supply voltage is greater than or equal to the threshold value in step S16 (Yes in step S16), the data saving unit 82 determines whether the user data converted to the format of FIG. 4 is included in the saving area 71 (step S18). When the user data is included (Yes in step S18), the user data included in the saving area 71 is deleted (step S19), and the operation proceeds to step S12. When the user data is not included (No in step S18), the operation directly proceeds to step S12. After step S12, the determination of step S11 is further performed.

Next, an operation of the storage device 1 at the time of a power resupply after power is abnormally cut off is described with reference to FIG. 3. When power is resupplied after power is abnormally cut off (step S21), the data rewriting unit 83 determines whether the user data converted to the format of FIG. 4 is included in the saving area 71 (step S22). When the user data is included in the saving area 71 (Yes in step S22), the data rewriting unit 83 writes the user data included in the saving area 71 in a format writable in the normal area 70 (step S23). The writing may be the same as in the writing scheme in the normal process, and thus either a multi-value recording (MLC: multi-level cell) scheme or the binary recording (SLC: single-level cell) scheme may be used. Thereafter, a normal process is performed (step S24). When the user data is not included in the saving area 71 in step S22 (No in step S22), the normal process is performed (step S24).

The storage device of this embodiment may save user data on a volatile memory in a non-volatile memory based on determination of the storage device regardless of a shutdown operation by an OS of a host device at the time of a power-supply voltage drop, and thus user data and the like to be retained may be appropriately retained even when insufficient time exists until the host device is shut down.

### Second Embodiment

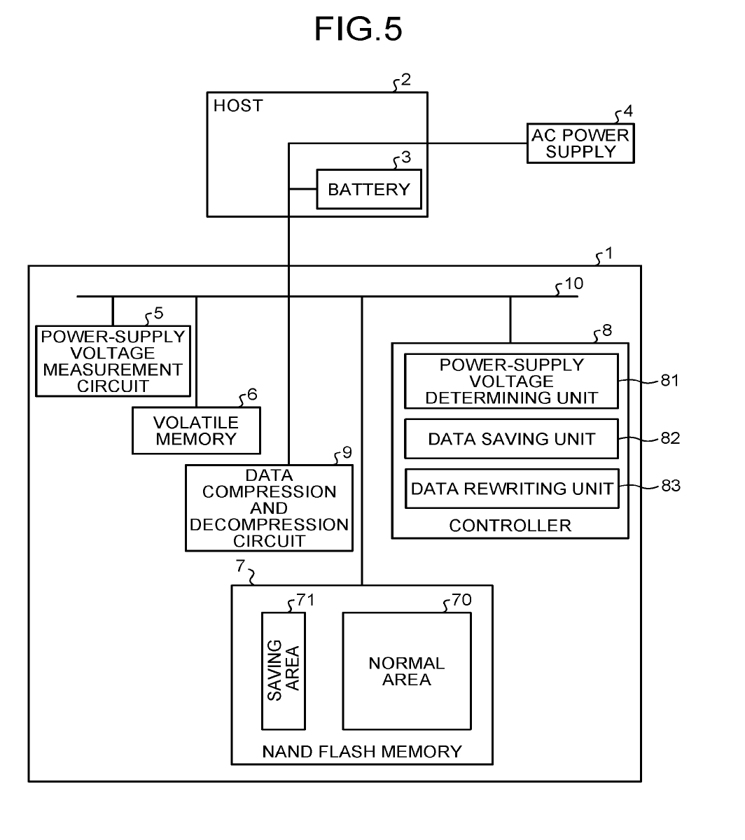

FIG. 5 is a diagram illustrating a configuration of a storage device 1 according to this embodiment together with a host 2. The configuration of the storage device 1 of FIG. 5 is constructed by adding a data compression and decompression circuit 9 to the configuration of the storage device 1 of FIG. 1. For example, the data compression and decompression circuit 9 compresses and decompresses user data by using a compression algorithm of a conventional lossless compression scheme, for example, a range coder, a dynamic Huffman coding, a run-length compression, and an MH coding. A scheme of compressing and decompressing user data by the data compression and decompression circuit 9 is not limited thereto, and a conventional scheme or a new scheme may be used.

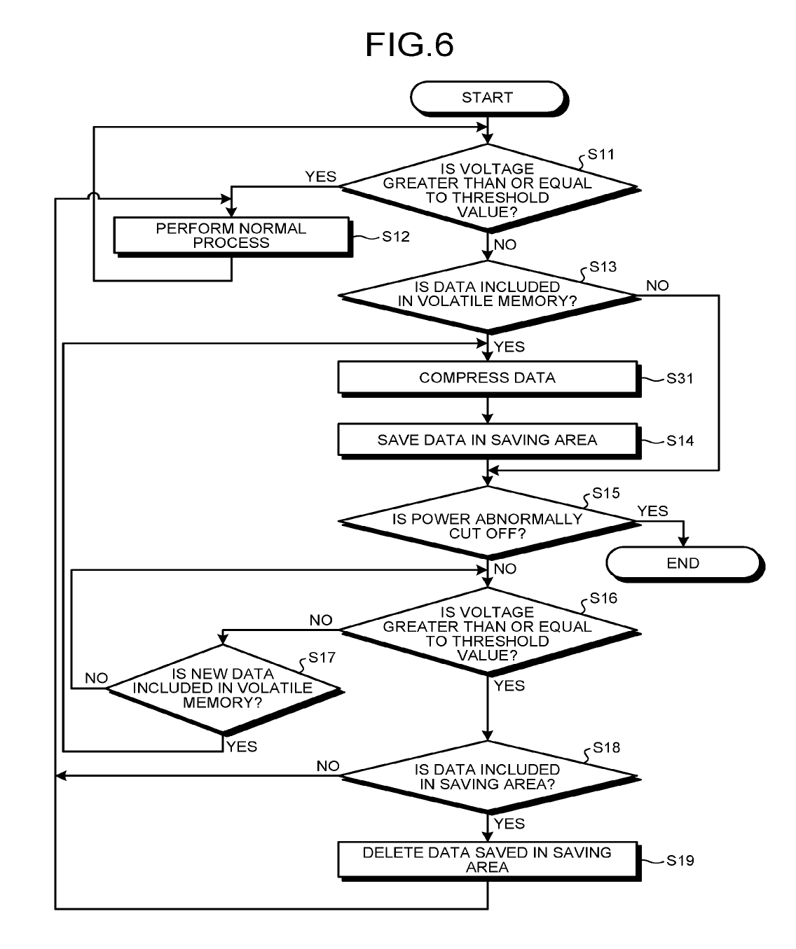

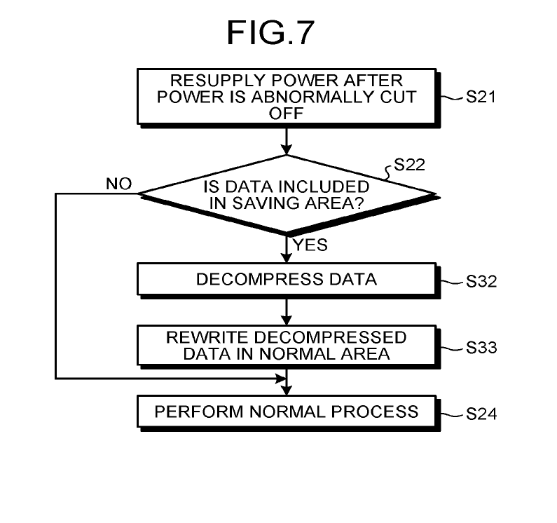

Hereinafter, an operation of the storage device 1 of this embodiment will be described using flowcharts of FIGS. 6 and 7.

FIG. 6 is a flowchart illustrating an operation of the storage device 1 until power is abnormally cut off in this embodiment. The flowchart of FIG. 6 is constructed by adding step S31 before step S14 in the flowchart of FIG. 2.

That is, in this embodiment, instead of converting the user data included in the volatile memory 6 to the format illustrated in FIG. 4 when a power-supply voltage supplied from the host 2 is less than the threshold voltage, the user data is compressed as image data by the data compression and decompression circuit 9 (step S31), and the compressed user data (compression user data) is written and saved in the saving area 71 by the data saving unit 82 (step S14). Specifically, when the user data is included in the volatile memory 6 (Yes in step S13), and when the new user data is included in the volatile memory 6 (Yes in step S17), the user data is compressed by the data compression and decompression circuit 9 (step S31), and is saved in the saving area 71 (step S14). Description of another operation is similar to those of FIG. 2 in the first embodiment, and thus is not presented.

FIG. 7 is a flowchart illustrating an operation of the storage device 1 at the time of a power resupply after power is abnormally cut off in this embodiment. The flowchart of FIG. 7 is constructed by adding step S32 before step S23 in the flowchart of FIG. 3, and replacing step S23 by step S33. That is, in this embodiment, when power is resupplied after power is abnormally cut off (step S21), and the user data is included in the saving area 71 (Yes in step S22), the data compression and decompression circuit 9 decompresses the compressed user data included in the saving area 71 (step S32), and the data rewriting unit 83 writes the decompressed user data in the normal area 70 (step S33). Description of another operation is similar to that of FIG. 3 in the first embodiment, and thus is not presented.

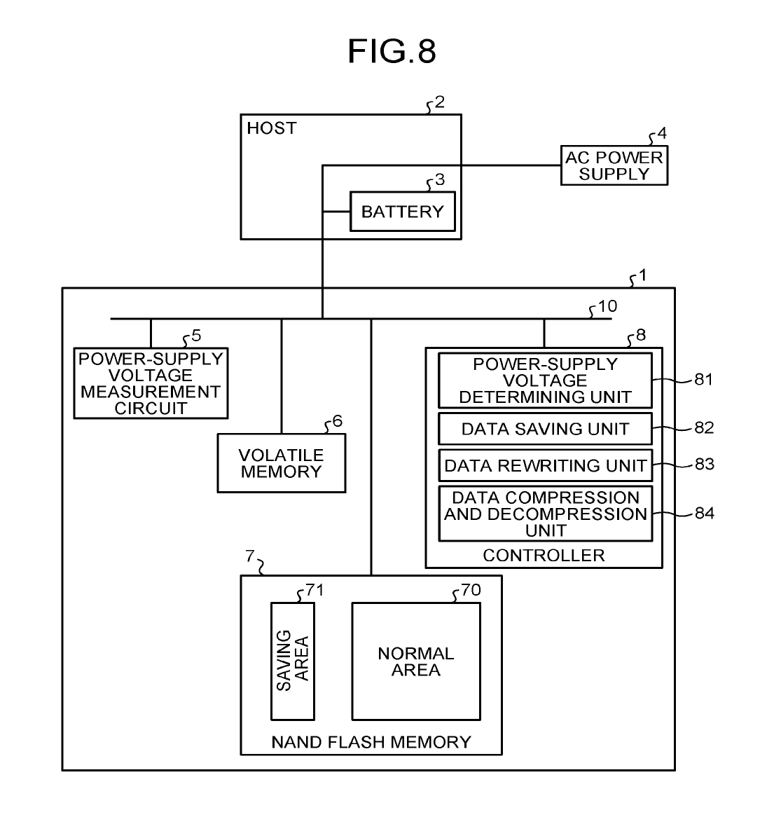

In the above description, as illustrated in FIG. 5, the data compression and decompression circuit 9 is provided separately from the controller 8 in the storage device 1. However, as illustrated in FIG. 8, without providing the data compression and decompression circuit 9, a function of the data compression and decompression circuit 9 may be assumed by a data compression and decompression unit 84 in the controller 8 as a function of a firmware.

In the storage device of this embodiment, user data on a volatile memory may be saved in a non-volatile memory based on determination of the storage device at the time of a power-supply voltage drop, and thus user data and the like to be retained may be appropriately retained even when insufficient time exists until a host device is shut down.

### Third Embodiment

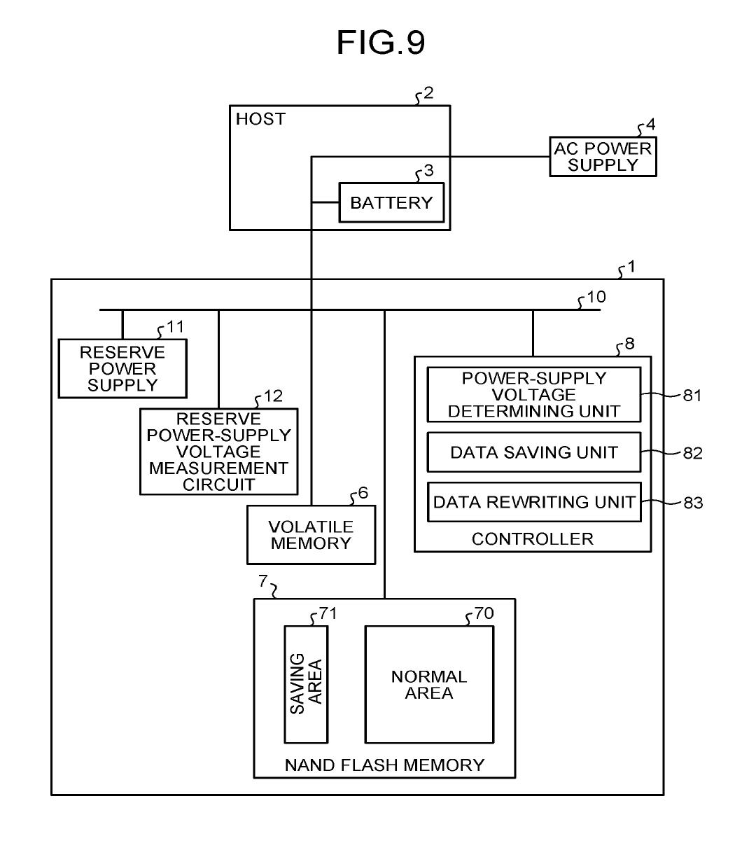

A configuration of a storage device of this embodiment is a configuration illustrated in a storage device 1 of FIGS. 9, 10, and 11 respectively provided with a reserve power supply 11 and a reserve power-supply voltage measurement circuit 12 instead of the power-supply voltage measurement circuit 5 that is provided in FIGS. 1, 5, and 8. The reserve power supply 11 is a power supply including a super capacitor and the like provided in the inside of the storage device 1, and is a power supply different from power supplied from the outside such as a host 2 and the like. When the reserve power supply 11 is included, the storage device 1 may independently operate even when the storage device 1 is isolated from the host 2 and the like. The reserve power-supply voltage measurement circuit 12 is a circuit that monitors a driving force of the reserve power supply 11, that is, an electric charge remaining in a capacitor included in the reserve power supply 11. Specifically, the reserve power-supply voltage measurement circuit 12 measures a voltage illustrating a driving force of the reserve power supply 11.

The reserve power supply 11 is originally used as a reserve power supply separately from main power supplied from the host and the like. However, when a voltage of the reserve power supply 11 is less than a predetermined threshold value, the storage device 1 of this embodiment saves and appropriately retains user data on a volatile memory in a non-volatile memory from a viewpoint of prevention expecting a risk of main power loss period and the like.

A flowchart illustrating an operation of the storage device 1 of FIG. 9 until power is abnormally cut off and an operation at the time of a power resupply after power is abnormally cut off is similar to that of FIGS. 2 and 3. However, in this embodiment, in steps S11 and S16 of FIG. 2, it is determined whether a voltage of the reserve power supply 11 measured by the reserve power-supply voltage measurement circuit 12 is greater than or equal to a predetermined threshold value or not.

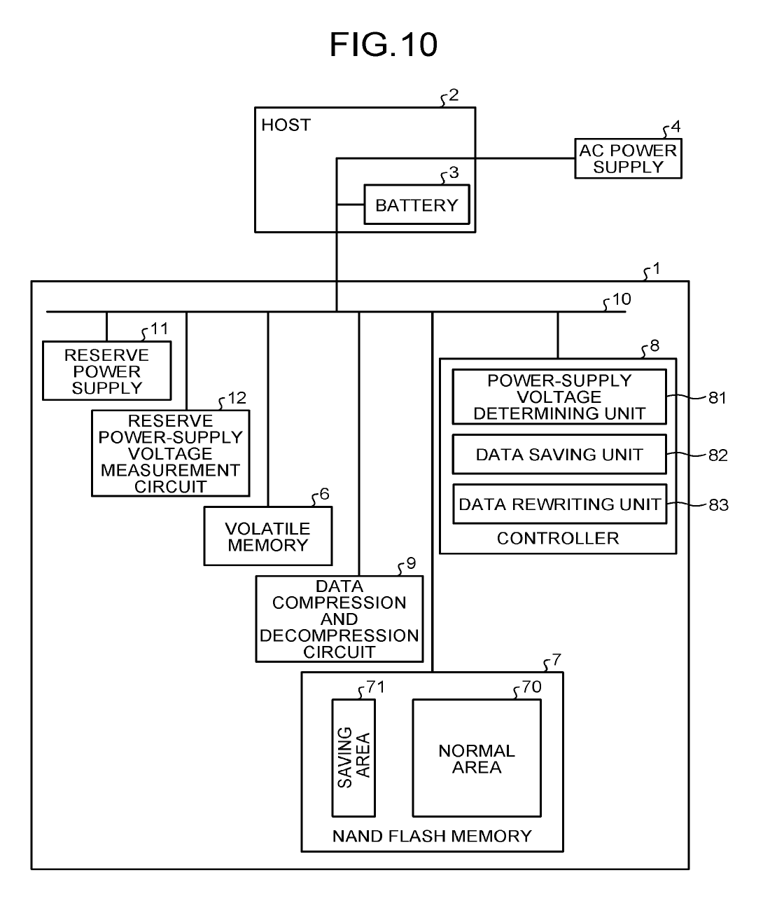

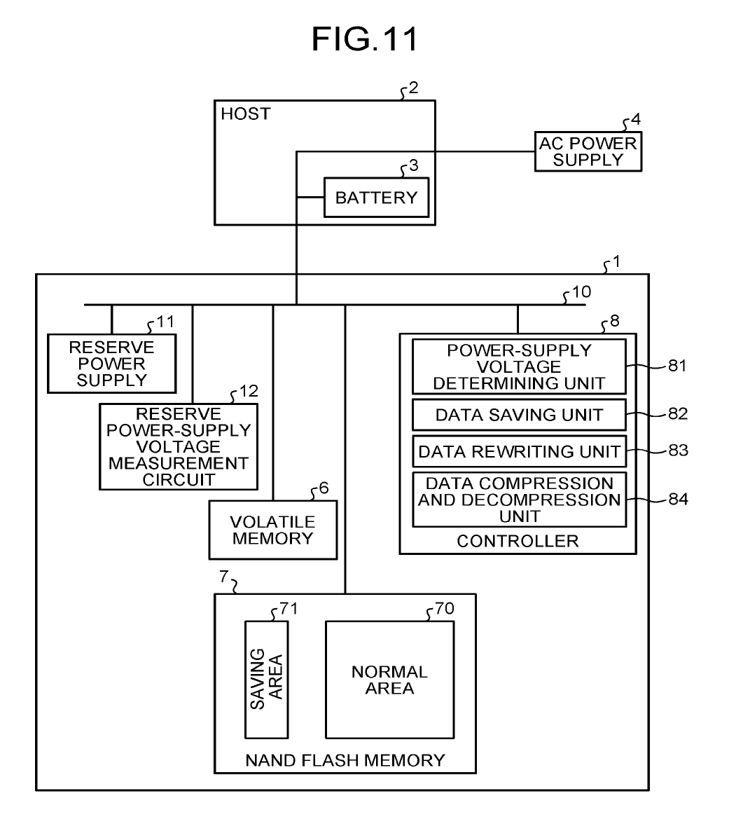

Similarly, a flowchart illustrating an operation of the storage device 1 of FIGS. 10 and 11 until power is abnormally cut off and an operation at the time of a power resupply after power is abnormally cut off is similar to those of FIGS. 6 and 7. However, in this embodiment, in steps S11 and S16 of FIG. 6, it is determined whether a voltage of the reserve power supply 11 measured by the reserve power-supply voltage measurement circuit 12 is greater than or equal to a predetermined threshold value or not.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1-20. (canceled)

21. A storage device, comprising:
an interface configured to be connected to a host;
a volatile memory;
a non-volatile memory including a reserved memory area which is reserved for data protection in case of power loss instances; and
a controller configured to write first data from the host into the volatile memory;
wherein
the reserved memory area is a part of a flash memory component,
in a case that a power from the host is less than a threshold, the controller uses the reserved memory area to protect the first data stored in the volatile memory, and after the first data is stored in the reserved memory area, the first data is moved to an other part of the non-volatile memory.

22. The storage device according to claim 21, wherein,
in a case that a power from the host is less than a threshold, the controller writes the first data stored in the volatile memory into the reserved memory area.

23. The storage device according to claim 21, wherein,
in a case that the power from the host is less than the threshold, the controller converts, from a first format into a second format, the first data stored in the volatile memory and writes the converted first data to the reserved memory area, and
by using the power from the host, the controller reads the first data stored in the reserved memory area, converts, from the second format to the first format, the read first data, and writes the converted first data into the other part of the non-volatile memory.

24. The storage device according to claim 23, wherein
the first format is a multi-value recording format, and
the second format is a binary recording format.

25. The storage device according to claim 21, wherein,
in a case that the power from the host is less than the threshold, the controller writes second data to the reserved memory area, the second data including the first data stored in the volatile memory, LBA, and sector information, and
by using the power from the host, the controller reads the second data out of the reserved memory area and writes the first data into the other part of the non-volatile memory.

26. The storage device according to claim 21, wherein,
in a case that the power from the host is less than the threshold, the controller compresses the first data stored in the volatile memory and writes the compressed first data to the reserved memory area,
by using the power from the host, the controller decompresses the read first data out of the reserved memory area and writes the decompressed first data to the other part of the non-volatile memory

[symbol]

27. The storage device according to claim 21, wherein, after the first data is written to the reserved memory area, when the power from the host is greater than the threshold, the controller deletes the first data stored in the reserved memory area.
